(19) United States
(12) Patent Application Publication
(10) Pub. No.: US 2024/0278582 A1
(43) Pub. Date: Aug. 22, 2024

(54) PROCESSING LIQUID DISCHARGE DEVICE

(71) Applicant: BROTHER KOGYO KABUSHIKI KAISHA, Nagoya (JP)

(72) Inventors: Shunsuke OKAI, Nagoya (JP); Yutaka TAKAGIWA, Kariya (JP)

(21) Appl. No.: 18/422,903

(22) Filed: Jan. 25, 2024

(30) Foreign Application Priority Data
Feb. 21, 2023 (JP) 2023-024945

(51) Int. Cl. B41J 2/175; B41J 2/045; B41J 2/135

(52) U.S. Cl. CPC B41J 2/17596; B41J 2/04501; B41J 2/135

(57) ABSTRACT

A processing liquid discharge device includes: an accommodation unit configured to accommodate a processing liquid; a spray nozzle; a supply flow path for supplying the processing liquid from the accommodation unit to the spray nozzle; a pump; a valve provided in the supply flow path between the spray nozzle and the pump; a circulation flow path including one end being connected to the supply flow path between the valve and the pump, or to the valve, and the other end being connected to the supply flow path between the pump and the accommodation unit, or to the accommodation unit; and a controller that controls the valve to be set in a communication state after activating the pump to cause the processing liquid to flow from the supply flow path to the circulation flow path while controlling the valve to be set in a cut-off state.

### REFERENCE TO RELATED APPLICATIONS

This application claims priority from Japanese Patent Application No. 2023-024945 filed on Feb. 21, 2023. The entire disclosure of the Japanese Patent Application is incorporated herein by reference.

### BACKGROUND ART

A related-art textile printing apparatus is suggested, which is configured to include a pretreatment agent application unit for applying, to a textile-printing medium as a printing medium, a pretreatment agent for fixing a printing liquid. The pretreatment agent application unit of the textile printing apparatus is connected to a tank where the pretreatment agent is stored via a flow path, and the pretreatment agent is supplied from the tank. When printing an image on the textile-printing medium, the textile printing apparatus applies the pretreatment agent to the textile-printing medium by using the pretreatment agent application unit, and then discharges the printing liquid onto a lower base layer formed by using the pretreatment agent. In this manner, the image is printed on the textile-printing medium.

### DESCRIPTION

The inventor of the present disclosure has considered that a spray nozzle for discharging the processing liquid to the printing medium is adopted, and a pump is provided in a flow path connecting the spray nozzle and the tank. Then, the present inventor has examined that the pretreatment agent stored in the tank is supplied to the spray nozzle by activating the pump, and the pretreatment agent is applied to the printing medium by using the pretreatment agent discharged from the spray nozzle. When the pump is activated at a timing at which the pretreatment agent is applied from the spray nozzle to the printing medium, since a supply pressure of the pretreatment agent to the spray nozzle is small at a timing of starting to activate the pump, the pretreatment agent is not discharged from the spray nozzle in the form of mist, and the pretreatment agent is discharged collectively from the spray nozzle so as to drip down. As a result, there is a problem that the pretreatment agent discharged in the form of drip is sparsely applied to the printing medium, and there is a problem that when the pretreatment agent is dropped onto the printing medium, a platen that supports the printing medium, and the like, the pretreatment agent is likely to scatter, and the apparatus or the like is contaminated.

Accordingly, an object of the present disclosure is to provide a processing liquid discharge device capable of easily discharging a processing liquid in the form of mist at the start of discharging the processing liquid from a spray nozzle.

According to the present disclosure, there is provided a processing liquid discharge device including: an accommodation unit configured to accommodate a processing liquid for forming a lower base layer or an upper base layer of an ink discharged onto a printing medium by using an ink jet printer; a spray nozzle configured to discharge the processing liquid accommodated in the accommodation unit; a supply flow path for supplying the processing liquid from the accommodation unit to the spray nozzle; a pump provided in the supply flow path and configured to supply the processing liquid accommodated in the accommodation unit to the spray nozzle; a valve provided in the supply flow path between the spray nozzle and the pump; a circulation flow path including one end being connected to the supply flow path between the valve and the pump, or to the valve, and the other end being connected to the supply flow path between the pump and the accommodation unit, or to the accommodation unit; and a controller configured to control the pump and the valve. When causing the processing liquid to be discharged from the spray nozzle, the controller controls the valve to be set in a communication state where the pump and the spray nozzle communicate with each other after activating the pump to cause the processing liquid to flow from the supply flow path to the circulation flow path while controlling the valve to be set in a cut-off state where communication between the pump and the spray nozzle is cut off.

According to the processing liquid discharge device of the present disclosure, the processing liquid is supplied to the spray nozzle in a state where when the processing liquid is discharged from the spray nozzle, a supply pressure of the processing liquid in the supply flow path is higher than that when the processing liquid is simply supplied to the spray nozzle at the timing of starting to activate the pump by causing the processing liquid to flow from the supply flow path to the circulation flow path and then setting the valve from the cut-off state to the fluid communication state. Therefore, the processing liquid is easily discharged in the form of mist from the spray nozzle when the supply of the processing liquid to the spray nozzle is started. As a result, the processing liquid can be discharged in the form of mist onto a desired printing medium.

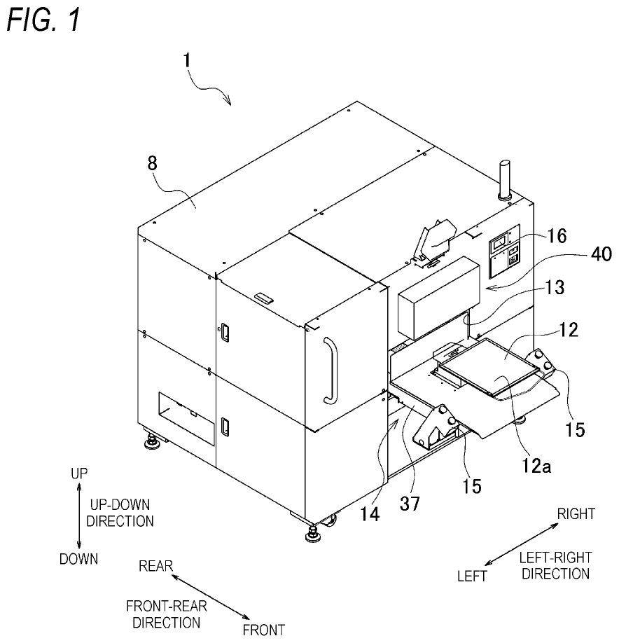

FIG. 1 is a schematic perspective view of a printing apparatus as a processing liquid discharge device according to an embodiment of the present disclosure,

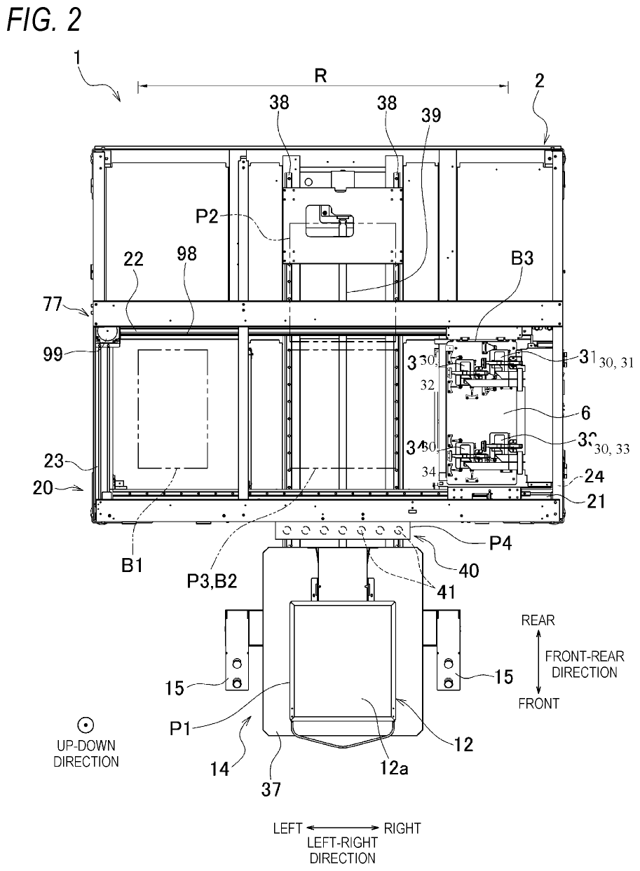

FIG. 2 is a plan view illustrating an internal structure of the printing apparatus illustrated in FIG. 1.

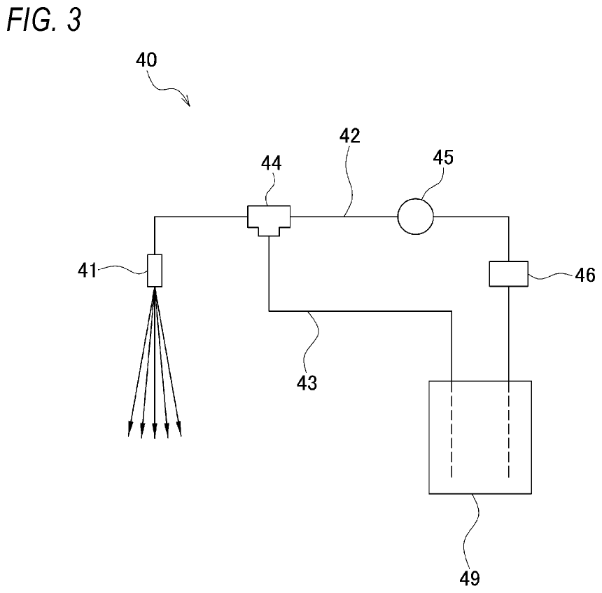

FIG. 3 is a schematic view of a processing liquid discharge unit illustrated in FIG. 1.

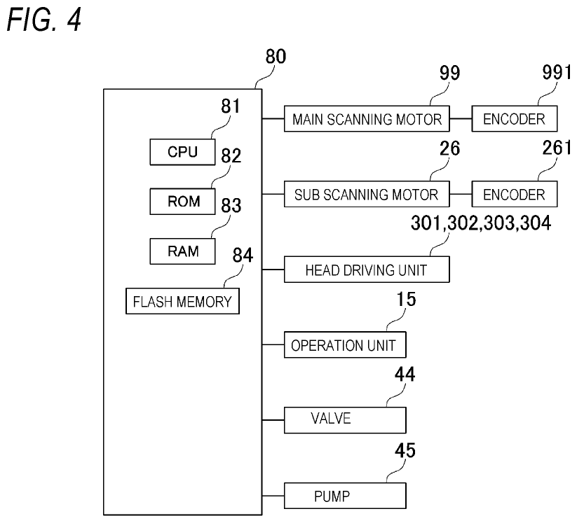

FIG. 4 is a block diagram illustrating an electrical configuration of the printing apparatus illustrated in FIG. 1.

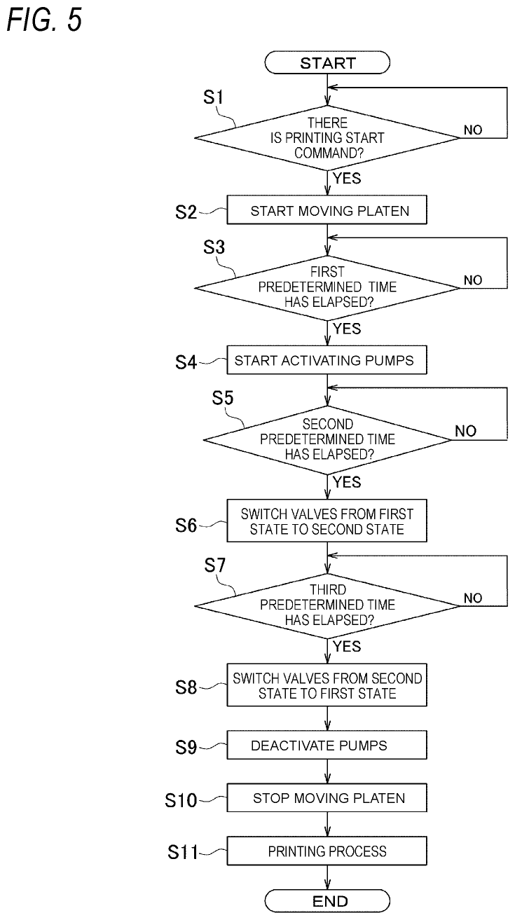

FIG. 5 is a flowchart illustrating an example of a processing procedure executed when a printing start command is input to the printing apparatus illustrated in FIG. 1.

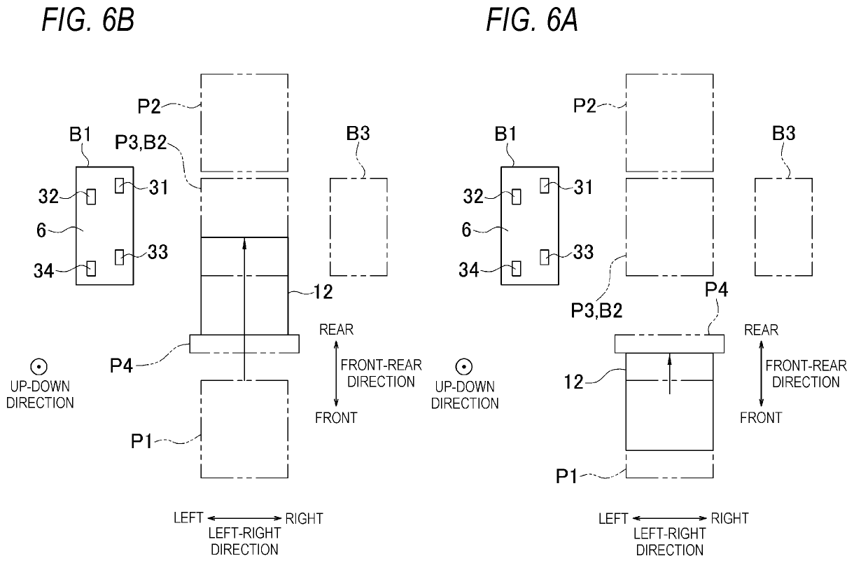

FIG. 6A is a diagram illustrating a situation when a platen reaches a processing liquid discharge region from a setting position, and FIG. 6B is a diagram illustrating a situation when the platen passes through the processing liquid discharge region.

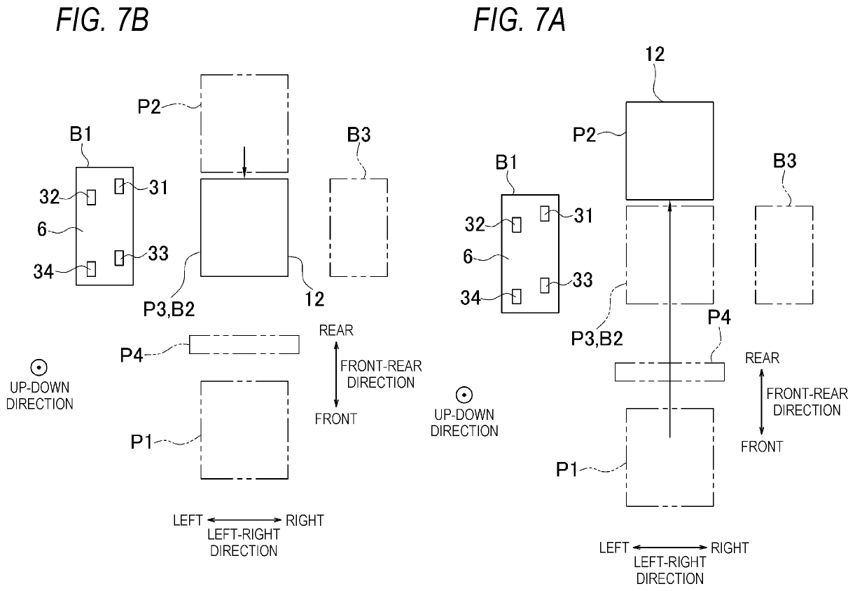

FIG. 7A is a diagram illustrating a situation when the platen is conveyed to a pre-printing standby position, and FIG. 7B is a diagram illustrating a situation when the platen is conveyed to a printing region.

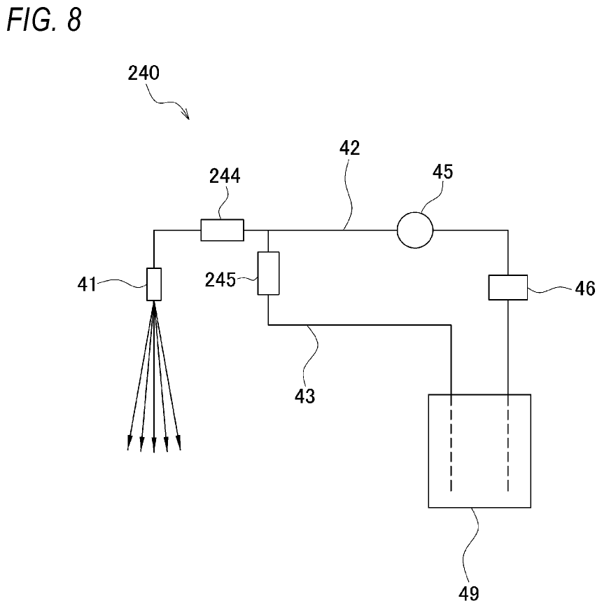

FIG. 8 is a schematic view of a processing liquid discharge unit according to a modification of the present disclosure.

A printing apparatus 1 including a processing liquid discharge device according to the present disclosure will be described with reference to the drawings. In the following description, an up-down direction and a front-rear direction are defined based on a state where the printing apparatus 1 is installed in a usable manner (the state of FIG. 1), and a left-right direction is defined when the printing apparatus 1 is seen from the front. In the following description, the left-right direction may be referred to as a main scanning direction, and the front-rear direction may be referred to as a sub scanning direction.

The printing apparatus 1 illustrated in FIG. 1 includes an ink jet printer that discharges an ink onto a printing medium and performs printing. The printing apparatus I can print a color image on the printing medium by using inks of five colors including white, black, yellow, cyan, and magenta. The printing medium is not particularly limited as long as an image can be formed thereon by discharging an ink, and examples thereof include fabric and paper. In the present embodiment, the printing medium is, for example, a T-shirt containing polyester fibers. When the printing apparatus 1 performs the printing on the printing medium (the T-shirt), a processing liquid for forming a lower base layer onto which the inks are discharged is applied to the printing medium. The processing liquid reacts with the inks discharged onto the lower base layer to aggregate components of the inks, thereby preventing the occurrence of bleeding. A volatile component of the processing liquid includes an organic acid such as a formic acid.

Hereinafter, the ink of white among the inks of the five colors is referred to as the “white ink”. When the inks of the four colors including black, cyan, yellow, and magenta among the inks of the five colors are collectively referred to, or when none of the inks of the four colors is specified, the inks are referred to as the “color ink”. When the white ink and the color ink are collectively referred to, or when either of the inks is not specified, the white ink and the color ink are simply referred to as the “ink”. The white ink is used for the printing as a part representing the white of the image, or as a base of the color ink. The color ink is discharged onto the base formed by using the white ink and is used for the printing of the color image.

An appearance configuration of the printing apparatus 1 will be described with reference to FIGS. 1 and 2. As illustrated in FIG. 1, the printing apparatus 1 includes a housing 8, a platen 12, a platen moving mechanism 14, operation units 15, a display screen 16, a processing liquid discharge unit 40, and a controller 80. The platen 12, the platen moving mechanism 14, the processing liquid discharge unit 40, and the controller 80 correspond to the “processing liquid discharge device” according to the present disclosure. In addition, an ink jet printer portion is constituted by the components excluding the processing liquid discharge unit 40 of the printing apparatus 1. The housing 8 has a substantially rectangular parallelepiped shape, and a rectangular-shaped platen opening 13 is formed at a substantial center of a front surface in the left-right direction and the up-down direction. Five cartridges (not shown) in which the inks of the five colors are respectively accommodated are stored in the housing 8. As illustrated in FIG. 2, the platen 12 is implemented by a plate-shaped member having a substantially rectangular planar shape. An upper surface of the platen 12 is a support surface 12a that supports the printing medium. The support surface 12a has a square shape.

The operation units 15 are respectively provided at both left and right end portions of a platen support portion 37 (to be described later) protruding forward from the platen opening 13. The operation units 15 output information corresponding to an operation performed by a user to the controller 80 to be described later. The user can input a printing start command (including printing data) for starting printing by the printing apparatus 1, and the like to the controller 80 by operating the operation units 15. The display screen 16 is provided on an upper portion on a right side of the platen opening 13 in the front surface of the housing 8. The display screen 16 displays various kinds of information.

The platen moving mechanism 14 moves the platen 12, on which the printing medium is disposed, between the inside and the outside of the housing 8 through the platen opening 13. When the platen 12 is disposed in a processing liquid discharge region P4, the processing liquid is discharged from the processing liquid discharge unit 40, and the processing liquid is applied to the printing medium. Further, when the platen 12 is disposed in a printing region P3 (a position indicated by a two-dot chain line in FIG. 2) inside the housing 8 illustrated in FIG. 2, the ink is discharged from heads 30, which are described later, and the printing is performed. As illustrated in FIG. 2, the platen moving mechanism 14 includes the platen support portion 37, a pair of right and left rails 38, a transmission member 39, and a sub scanning motor 26 (see FIG. 4).

As illustrated in FIGS. 1 and 2, the platen support portion 37 supports the platen 12 from below. As illustrated in FIG. 2, the pair of left and right rails 38 extend in the front-rear direction and support the platen support portion 37 so as to be movable in the front-rear direction. The transmission member 39 is coupled to the platen support portion 37 and the sub scanning motor 26, and moves the platen support portion 37 in the front-rear direction, that is, the sub scanning direction, in response to driving of the sub scanning motor 26.

An operator places the printing medium on the support surface 12a of the platen 12 when the platen 12 is disposed in front of the front surface of the housing 8, that is, outside the housing 8. The position of the platen 12 illustrated in FIG. 2 is a setting position P1 at which the printing medium is supported by the platen 12. The processing liquid discharge region P4 is a region that is present in the middle of a movement path of the platen 12 and where the processing liquid is discharged from a spray nozzle 41 (to be described later) of the processing liquid discharge unit 40, and is present below the spray nozzle 41 (that is, in a discharge direction of the processing liquid). A width of the processing liquid discharge region P4 in the left-right direction is equal to or larger than a width of the platen 12 in the left-right direction. Before printing on the printing medium, the platen 12 moves from the setting position P1 to a pre-printing standby position P2 (a position indicated by a two-dot chain line in FIG. 2). The pre-printing standby position P2 is located behind the processing liquid discharge region P4 and the printing region P3, and is located at a rear end portion of the movement path of the platen 12. The printing region P3 is a region that overlaps a movement path of the heads 30 in the main scanning direction (the left-right direction) in the up-down direction in the movement path of the platen 12. The movement path of the heads 30 in the main scanning direction is a path between a rear end of the rearmost head 30 (a white ink head 31) and a front end of the foremost head 30 (a color ink head 34).

An internal structure of the printing apparatus 1 will be described. As illustrated in FIG. 2, the printing apparatus 1 includes a frame 2, the heads 31 to 34, and a moving mechanism 77 inside the housing 8. The frame 2 is configured in a grid shape by a plurality of shafts extending in the front-rear direction, the left-right direction, and the up-down direction. The moving mechanism 77 includes a guide shaft 20 fixed to the frame 2 and a carriage 6. As illustrated in FIG. 2, the guide shaft 20 includes a front shaft 21, a rear shaft 22, a left shaft 23, and a right shaft 24. The heads 31 to 34 are collectively referred to as “heads 30” or simply “head 30” in singular when referring to one of the heads 31 to 34 in the present disclosure.

As illustrated in FIG. 2, the front shaft 21 is disposed at a front end portion of the frame 2 and extends in the left-right direction from a left end portion to a right end portion of the frame 2. The rear shaft 22 is disposed at a substantial center of the frame 2 in the front-rear direction, and extends in the left-right direction from the left end portion to the right end portion of the frame 2. The left shaft 23 is disposed at the left end portion of the frame 2, and extends in the front-rear direction from a left end of the front shaft 21 to a left end of the rear shaft 22. The right shaft 24 is disposed at the right end portion of the frame 2, and extends in the front-rear direction from a right end of the front shaft 21 to a right end of the rear shaft 22. The front shaft 21 and the rear shaft 22 support the carriage 6. The platen moving mechanism 14 is fixed to the frame 2.

As illustrated in FIG. 2, the carriage 6 is supported by the front shaft 21 and the rear shaft 22 so as to be movable in the main scanning direction. The carriage 6 has a plate shape and extends in the front-rear direction and the left-right direction. The carriage 6 extends from the front shaft 21 to the rear shaft 22.

As illustrated in FIG. 2, the carriage 6 is provided with the white ink heads 31 and 32 and the color ink heads 33 and 34. The white ink heads 31 and 32 and the color ink heads 33 and 34 serves as the “heads” according to the present disclosure.

The white ink heads 31 and 32 and the color ink heads 33 and 34 have the same structure, and have a rectangular parallelepiped shape in the present embodiment. Hereinafter, when the white ink heads 31 and 32 and the color ink heads 33 and 34 are collectively referred to, or when neither the white heads 31 and 32 nor the color heads 33 and 34 are specified, the white heads 31 and 32 and the color heads 33 and 34 are referred to as the “heads 30”. As illustrated in FIG. 2, the white ink heads 31 and 32 are located at a rear portion of the carriage 6. The white ink head 31 is located at a right rear portion of the carriage 6. The white ink head 32 is located on a left side of the white ink head 31 and is displaced forward with respect to the white ink head 31. A rear portion of the white ink head 32 overlaps a front portion of the white ink head 31 in the left-right direction.

As illustrated in FIG. 2, the color ink heads 33 and 34 are located in front of the white ink heads 31 and 32. The color ink heads 33 and 34 are located at the same positions as the white ink heads 31 and 32 in the left-right direction, respectively. That is, the white ink heads 31 and 32 and the color ink heads 33 and 34 are arranged side by side along the sub scanning direction. The color ink head 34 is located on a left side of the color ink head 33 and is displaced forward with respect to the color ink head 33. A rear portion of the color ink head 34 overlaps a front portion of the color ink head 33 in the left-right direction.

A plurality of nozzles (not shown) are formed on lower surfaces of these heads 30. The nozzles of the white ink heads 31 and 32 discharge the white ink downward. The nozzles of each of the color ink heads 33 and 34 are disposed such that four nozzle rows each extending in the front-rear direction are arranged in the left-right direction. The color ink of different colors correspond to the four nozzle rows of each of the color ink heads 33 and 34, respectively. That is, the nozzles of each of the color ink heads 33 and 34 discharge the color ink of the colors respectively corresponding to the nozzle rows downward.

The moving mechanism 77 includes a driving belt 98 and a main scanning motor 99. The driving belt 98 is coupled to a rear end portion of the carriage 6. The driving belt 98 is provided on the rear shaft 22 and extends in the left-right direction. A left end portion of the driving belt 98 is coupled to the main scanning motor 99. When the main scanning motor 99 is driven, the driving belt 98 moves the carriage 6 in the left-right direction along the front shaft 21 and the rear shaft 22. That is, the moving mechanism 77 moves the carriage 6 on which the heads 30 are mounted in the main scanning direction. FIG. 2 illustrates a state where the carriage 6 is located on a right side of a movement range R.

In FIG. 2, the movement range R of the heads 30 is illustrated as a maximum range in which the carriage 6 can move in the main scanning direction. The heads 30 are mainly disposed at any one of a maintenance position B1, a discharge region B2, and a head standby position B3 by the moving mechanism 77. The maintenance position BI is at a left end of the movement range R of the heads 30, and is a position where the heads 30 are maintained by a maintenance unit such as a wiper (not shown) or a cap (not shown). The printing apparatus 1 moves the heads 30 to the maintenance position B1 during non-printing, and performs the maintenance by the maintenance unit. The discharge region B2 is a region that is located between the maintenance position B1 and the head standby position B3 in the main scanning direction, and overlaps the movement path (the printing region P3) of the platen 12 in the up-down direction in the movement path of the heads 30. When the heads 30 passes through the discharge region B2 by the carriage 6, the heads 30 discharge the ink according to the printing data, and the printing is performed on the printing medium on the platen 12. The head standby position B3 is at a right end of the movement range R of the heads 30, and is a position where the operator performs an operation such as cleaning the heads 30. For example, the printing apparatus 1 moves the heads 30 to the head standby position B3 and causes the heads 30 to stand by based on an instruction input from the operation units 15 by a user operation.

The printing apparatus 1 moves the platen 12 in the sub scanning direction by the driving of the sub scanning motor 26 in the printing region P3 and moves the carriage 6 in the main scanning direction by the driving of the main scanning motor 99 in the discharge region B2, and thus the printing medium moves relative to the heads 30 in the sub scanning direction and the main scanning direction.

An operation of moving the heads 30 in the main scanning direction and discharging the ink onto the printing medium when the heads 30 face the printing medium is referred to as “discharge scanning”. The printing apparatus 1 performs the printing on the printing medium by repeating the discharge scanning and the movement of the platen 12 in the sub scanning direction. For example, the printing apparatus 1 discharges the white ink from the white ink heads 31 and 32 to form the base of the color ink on the printing medium in the discharge scanning. The printing apparatus 1 prints the color image by discharging the color ink from the color ink heads 33 and 34 onto the base formed on the printing medium in the discharge scanning.

As illustrated in FIG. 2, the processing liquid discharge unit 40 includes seven spray nozzles 41 arranged side by side in the left-right direction. In addition, as illustrated in FIG. 3, the processing liquid discharge unit 40 includes a tank 49 (an “accommodation unit” according to the present disclosure) that accommodates the processing liquid, and a supply member 42, a circulation member 43, a valve 44, a pump 45, and a filter 46 that are provided for each spray nozzle 41. That is, the processing liquid discharge unit 40 includes the supply members 42, the circulation members 43, the valves 44, the pumps 45, and the filters 46 that have the same number as the spray nozzles 41. FIG. 3 illustrates the supply member 42, the circulation member 43, the valve 44, the pump 45, and the filter 46 provided for one spray nozzle 41.

Since configurations of the supply member 42, the circulation member 43, the valve 44, and the pump 45 for the respective spray nozzles 41 are the same, a configuration corresponding to one spray nozzle 41 will be described. The spray nozzle 41 is connected to the supply member 42, and has a discharge port on a lower surface of the spray nozzle 41. Further, the spray nozzle 41 is capable of discharging the processing liquid in the form of mist downward from the discharge port when the processing liquid is supplied at a predetermined pressure or higher. Most of the processing liquid discharged from the seven spray nozzles 41 is discharged into the processing liquid discharge region P4.

The supply member 42 is a piping member, has one end connected to the spray nozzle 41 and the other end connected to the tank 49, and supplies the processing liquid in the tank 49 to the spray nozzle 41. An internal flow path of the supply member 42 corresponds to a “supply flow path” according to the present disclosure.

The pump 45 is provided at a middle portion of the supply member 42, and is activated by the controller 80 to supply the processing liquid in the tank 49 to a spray nozzle 41 side. The filter 46 filters an impurity from the processing liquid, and is provided in the supply member 42 between the pump 45 and the tank 49. Since the filter 46 is provided in the supply member 42, the impurity can be filtered from the processing liquid flowing in the supply member 42 from the tank 49 to the pump 45.

The valve 44 is provided in the supply member 42 between the spray nozzle 41 and the pump 45. The valve 44 according to the present embodiment is a three-way valve that operates under the control of the controller 80, and is also connected to one end of the circulation member 43. Accordingly, the valve 44 can be selectively set to a first state or a second state, in the first state, a communication state where the circulation member 43 and the supply member 42 are communicated is set while a cut-off state where the communication between the pump 45 and the spray nozzle 41 is cut off is set, and in the second state, a cut-off state where the communication between the circulation member 43 and the supply member 42 is cut off is set while a communication state where the pump 45 and the spray nozzle 41 are communicated is set.

The circulation member 43 is also a piping member similar to the supply member 42, and has one end connected to the valve 44 and the other end connected to the tank 49. Accordingly, the circulation member 43 can circulate the processing liquid from the supply member 42 to the tank 49 when the valve 44 is set to the first state. An internal flow path of the circulation member 43 corresponds to a “circulation flow path” according to the present disclosure.

In such a configuration, when the controller 80 activates the pump 45 and sets the valve 44 to the first state, the processing liquid from the tank 49 can flow from the supply member 42 to the circulation member 43 and can circulate to the tank 49. In addition, when the controller 80 activates the pump 45 and sets the valve 44 to the second state, the processing liquid from the tank 49 can be supplied to the spray nozzle 41. The processing liquid supplied to the spray nozzle 41 is discharged in the form of mist from the spray nozzle 41. Accordingly, the processing liquid can be applied to the printing medium.

An electrical configuration of the printing apparatus 1 will be described with reference to FIG. 4. The controller 80 includes a CPU 81, a ROM 82, a RAM 83, and a flash memory 84. The CPU 81 controls the printing apparatus 1, and is electrically connected to the ROM 82, the RAM 83, and the flash memory 84. The ROM 82 stores control programs for the CPU 81 to control the operation of the printing apparatus 1, information necessary for the CPU 81 to execute various programs, and the like. The ROM 82 stores positions of the carriage 6 (the heads 30) based on, for example, a rotation angle of the main scanning motor 99, and stores positions of the platen 12 based on a rotation angle of the sub scanning motor 26. The RAM 83 temporarily stores various types of data used in the control programs. The flash memory 84 is nonvolatile and stores the printing data and the like for the printing.

As illustrated in FIG. 4, the main scanning motor 99, the sub scanning motor 26, four head driving units 301 to 304, the operation units 15, the seven valves 44, and the seven pumps 45 are electrically connected to the controller 80. The main scanning motor 99, the sub scanning motor 26, the head driving units 301 to 304, the seven valves 44, and the seven pumps 45 are activated under the control of the controller 80. Although the seven valves 44 and the seven pumps 45 are provided, one valve 44 and one pump 45 are illustrated in FIG. 4 for convenience.

The main scanning motor 99 and the sub scanning motor 26 are provided with encoders 991 and 261, respectively. The encoder 991 detects the rotation angle of the main scanning motor 99 and outputs a detection result to the controller 80. The encoder 261 detects the rotation angle of the sub scanning motor 26 and outputs a detection result to the controller 80.

The four head driving units 301 to 304 correspond to the white ink heads 31 and 32 and the color ink heads 33 and 34 in order, and are included in the heads 31 to 34, respectively. The respective head driving units 301 to 304 are implemented by a plurality of drive elements (piezoelectric elements or heating elements) capable of selectively applying energy to the ink in a plurality of individual flow paths respectively communicating with the plurality of nozzles of the heads 30. These head driving units 301 to 304 apply energy to the ink in the white ink heads 31 and 32 and the color ink heads 33 and 34 by driving the white ink heads 31 and 32 and the color ink heads 33 and 34, respectively, and selectively causes the ink to be discharged from corresponding nozzles 313, 323, 333, and 343.

### Control During Printing

The control of the controller 80 when the image is printed on the printing medium will be described with reference to FIG. 5. When the user operates the operation units 15 and inputs the printing start command to the printing apparatus 1, the controller 80 reads a control program from the ROM 82 and operates to execute the flow of FIG. 5. Hereinafter, the flow of FIG. 5 will be described.

First, the controller 80 determines whether the printing start command is input (S1). Before the user operates the operation units 15 to input the printing start command, the user disposes the printing medium (the T-shirt) to which the processing liquid is not applied on the support surface 12a of the platen 12. The platen 12 is disposed at the setting position P1 during non-printing. In the printing apparatus 1, during non-printing, the heads 30 are normally disposed at the maintenance position B1, and capping of covering the plurality of nozzles of the heads 30 is performed by the cap as the maintenance unit (not shown). Further, all the pumps 45 is deactivated, and all the valves 44 are set to the first state.

When the printing start command is not input (S1: NO), SI is repeated until the printing start command is input. On the other hand, when the printing start command is input (S1: YES), as illustrated in FIG. 6A, the controller 80 controls the sub scanning motor 26 to start moving the platen 12 from the setting position P1 toward the processing liquid discharge region P4.

Next, the controller 80 determines whether a first predetermined time has elapsed since the start of the movement of the platen 12 (S3). When the first predetermined time has not elapsed (S3: NO), S3 is repeated. On the other hand, when the first predetermined time has elapsed (S3: YES), the controller 80 starts activating all the pumps 45 (S4). In the present embodiment, a time required for the platen 12 to reach the processing liquid discharge region P4 from the setting position P1 is, for example, about several seconds. Therefore, the pumps 45 are started to be activated after one second (after the first predetermined time has elapsed) since the start of the movement of the platen 12. At this time, since the valve 44 is set to the first state, the processing liquid in the tank 49 flows from the supply member 42 of the corresponding spray nozzle 41 to the circulation member 43 and circulates to the tank 49 by the pump 45. Accordingly, the supply pressure of the processing liquid flowing through the supply member 42 can be increased by the corresponding pump 45.

Next, the controller 80 determines whether a second predetermined time has elapsed since the start of the movement of the platen 12 (S5). When the second predetermined time has not elapsed (S5: NO), S5 is repeated. On the other hand, when the second predetermined time has elapsed (S5: YES), the controller 80 controls all the valves 44 such that the valves 44 are switched from the first state to the second state (S6). Accordingly, the communication between the circulation member 43 and the supply member 42 is cut off, the pump 45 and the spray nozzle 41 communicate with each other, and the processing liquid is supplied from the supply member 42 to the spray nozzle 41 at the predetermined pressure or higher. Therefore, the processing liquid is discharged in the form of mist from the spray nozzle 41 almost at the same time as a switching timing of the valve 44. Further, the second predetermined time is longer than the first predetermined time, and is equal to a movement time from when the platen 12 is moved from the setting position P1 to when the platen 12 reaches the processing liquid discharge region P4. Therefore, the processing liquid is discharged from the spray nozzles 41 at a timing when the platen 12 reaches the processing liquid discharge region P4 (a “discharge position” according to the present disclosure) as illustrated in FIG. 6A. Therefore, the processing liquid discharged in the form of mist is applied to the printing medium supported by the platen 12 passing through the processing liquid discharge region P4. Therefore, the lower base layer is formed by substantially uniformly applying the processing liquid onto the printing medium.

Next, the controller 80 determines whether a third predetermined time has elapsed since the start of the movement of the platen 12 (S7). When the third predetermined time has not elapsed (S7: NO), S7 is repeated. On the other hand, when the third predetermined time has elapsed (S7: YES), the controller 80 controls all the valves 44 such that the valves 44 are switched from the second state to the first state (S8). Accordingly, the communication between the pump 45 and the spray nozzle 41 is cut off, the circulation member 43 and the supply member 42 communicate with each other, and the processing liquid flows from the supply member 42 to the circulation member 43 and circulates to the tank 49. Therefore, the supply of the processing liquid to the spray nozzle 41 is stopped, and the discharge of the processing liquid from the spray nozzle 41 is stopped almost at the same time as a switching timing of the valve 44. The third predetermined time is longer than the second predetermined time, and is equal to a movement time from when the platen 12 is moved from the setting position P1 to when the platen 12 passes through the processing liquid discharge region P4. Therefore, as illustrated in FIG. 6B, the discharge of the processing liquid from the spray nozzles 41 can be stopped at the timing when the platen 12 passes through the processing liquid discharge region P4 (that is, reaches a “discharge end position” according to the present disclosure). A position located behind the processing liquid discharge region P4 in the movement path of the platen 12 corresponds to a “passing position” according to the present disclosure. In the present embodiment, the processing liquid is controlled to be applied to an entire surface of the printing medium by controlling the processing liquid to be discharged to the entire support surface 12a of the platen 12, and the processing liquid may be applied to only a part of the printing medium in the front-rear direction by appropriately changing the second predetermined time and the third predetermined time. When the processing liquid is applied to only a part of the printing medium, the processing liquid may be applied to only a region corresponding to an image range formed by discharging the ink onto the printing medium.

The second predetermined time may be set to a time in which the supply pressure of the processing liquid flowing through the supply member 42 is equal to or higher than the predetermined pressure (a pressure at which the processing liquid can be discharged in the form of mist from the spray nozzles 41). In this manner, when the process proceeds from S5 to S6, the supply pressure becomes equal to or higher than the predetermined pressure, and thus the processing liquid is discharged in the form of mist from the spray nozzles 41. Further, a pressure detection unit that detects the supply pressure of the processing liquid flowing through the supply member 42 may be provided, and the controller 80 may determine whether the supply pressure detected by the pressure detection unit is equal to or higher than the predetermined pressure instead of S5 described above. When the supply pressure is less than the predetermined pressure (S5: NO), S5 is repeated. On the other hand, when the supply pressure is equal to or higher than the predetermined pressure (S5: YES), the controller 80 proceeds to S6. Also in this case, the processing liquid is discharged in the form of mist from the spray nozzles 41.

Next, the controller 80 deactivates all the pumps 45 (S9). Although S9 is executed immediately after S8 in the present embodiment, S8 and S9 may be simultaneously executed as long as S9 is not executed before S8. When S9 is executed before S8, the supply pressure of the processing liquid to the spray nozzle 41 is reduced when the pump 45 is deactivated, and a large amount of the processing liquid is collectively discharged to drip down from the spray nozzle 41, but the dripping down of the processing liquid from the spray nozzle 41 can be restrained by executing S8 before S9. Further, as the time from the switching timing of the valve 44 in S8 to the deactivation of the pump 45 decreases, it is possible to reduce an unnecessary activation time of the pump 45, and thus it is possible to extend a service life of the pump 45. When the processing liquid is selectively discharged from one spray nozzle 41 among the seven spray nozzles 41, the pump 45 and the valve 44 corresponding to the spray nozzle 41 are controlled as described above, and thus the processing liquid can be discharged in the form of mist from the selected spray nozzle 41. By selecting the spray nozzle 41 and discharging the processing liquid in this manner, an application range of the processing liquid on the printing medium in the left-right direction can be appropriately adjusted.

In the present embodiment, the processes of S4, S6, and S8 are executed at a timing at which the first predetermined time to the third predetermined time have elapsed since the start of the platen movement, and the processes of S4, S6, and S8 may be executed according to a position where the platen 12 is to be moved. In addition, S9 may be executed immediately after or at the same time as S8. That is, the controller 80 may execute S4 when a leading end of the platen 12 is between the setting position P1 and the processing liquid discharge region P4 based on the detection result from the encoder 261. Further, the controller 80 may execute S6 when the leading end of the platen 12 reaches the processing liquid discharge region P4 based on the detection result from the encoder 261. In addition, the controller 80 may execute S8 and S9 when a trailing end of the platen 12 passes through the processing liquid discharge region P4 based on the detection result from the encoder 261. In these cases, the same effect as described above can be obtained.

The movement of the platen 12 in the present embodiment is performed at a constant speed until the platen 12 reaches the pre-printing standby position P2 from the setting position P1, and a movement speed thereof may be changed for each section. For example, a movement speed at which the platen 12 passes through the processing liquid discharge region P4 may be smaller or larger than a movement speed at which the platen 12 reaches the processing liquid discharge region P4 after the conveyance of the platen 12 from the setting position P1 is started, and a movement speed at which the platen 12 passes through the processing liquid discharge region P4 and then reaches the pre-printing standby position P2. Further, the controller 80 may stop the movement of the platen 12 when the platen 12 reaches the processing liquid discharge region P4. Then, the movement of the platen 12 may be restarted at the switching timing of the valve 44 in S6. Further, the controller 80 may also stop the movement of the platen 12 when the platen 12 passes through the processing liquid discharge region P4. Then, the movement of the platen 12 may be restarted at the switching timing of the valve 44 in S8.

Next, as illustrated in FIG. 7A, the controller 80 controls the sub scanning motor 26 to stop the platen movement when the platen 12 reaches the pre-printing standby position P2 based on the detection result from the encoder 261 (S10).

Next, the controller 80 executes a printing process of printing the image on the printing medium (S11). The controller 80 controls the sub scanning motor 26 based on the detection result from the encoder 261 to move the platen 12 from the pre-printing standby position P2 to the printing region P3 as illustrated in FIG. 7B.

Then, the controller 80 controls the main scanning motor 99 based on the detection result from the encoder 991 to move the carriage 6 from the maintenance position BI to the discharge region B2 and cause the heads 30 to face the printing medium placed on the platen 12.

The controller 80 performs the printing on the printing medium by controlling the head driving units 301 to 304, the main scanning motor 99, and the sub scanning motor 26 and alternately repeating the discharge scanning and the forward movement of the platen 12 in a state where at least a part of the platen 12 is located in the printing region P3 and a state where the carriage 6 is located in the discharge region B2. That is, since the platen 12 is conveyed forward from the pre-printing standby position P2 to the printing region P3 at the time of the printing on the printing medium, first, the white ink is discharged from the nozzles of the white ink heads 31 and 32 onto the lower base layer of the printing medium formed by applying the processing liquid, and the base (mainly for the color ink) is formed. Then, the platen 12 passes through the white ink heads 31 and 32, the ink is discharged from the nozzles of the color ink heads 33 and 34 onto the base formed on the printing medium, and the image is formed. The part representing the white of the image is a base portion formed by using the white ink. Therefore, the color ink is not discharged onto the base portion.

Next, when the printing on the printing medium based on the printing data is ended (the printing process is ended), the controller 80 controls the sub scanning motor 26 based on the detection result from the encoder 261 to stop the platen 12 at the setting position P1. The user removes the printing medium on which the image is formed from the platen 12 disposed at the setting position P1. At this time, the controller 80 controls the main scanning motor 99 based on the detection result from the encoder 991 to move the carriage 6 leftward from the discharge region B2 and stop the carriage 6 at the maintenance position B1. Thus, the flow in FIG. 5 ends.

As described above, according to the printing apparatus 1 of the present embodiment, the processing liquid is supplied to the spray nozzle 41 in a state where when the processing liquid is discharged from the spray nozzle 41, the supply pressure of the processing liquid in the supply member 42 is higher than that when the processing liquid is simply supplied to the spray nozzle 41 at the timing of starting to activate the pump 45 by causing the processing liquid to flow from the supply member (the supply flow path) 42 to the circulation member (the circulation flow path) 43 and then setting the valve 44 into the communication state from the cut-off state. Therefore, the processing liquid is easily discharged in the form of mist from the spray nozzle 41 when the supply of the processing liquid to the spray nozzle 41 is started, and the processing liquid can be uniformly applied to the printing medium. As a result, the processing liquid is less likely to be sparsely applied to the printing medium, and when the processing liquid is dropped onto the printing medium, the platen 12, or the like, the processing liquid is less likely to scatter and the apparatus is less likely to be contaminated.

The controller 80 switches the valve 44 to the second state in S6 after the second predetermined time has elapsed since when the pump 45 is activated in S4. Accordingly, the control of setting the valve 44 from the cut-off state to the communication state is simplified.

The filter 46 is provided in the supply member 42. Accordingly, it is possible to filter the impurity from the processing liquid. Therefore, it is possible to restrain the occurrence of a failure such as clogging of the impurity in the spray nozzle 41.

The other end of the circulation member 43, whose one end is connected to the valve 44, is connected to the tank 49. Accordingly, it is possible to discharge bubbles entering into the supply member 42 via the circulation member 43 to the tank 49, and it is easy to discharge the bubbles from the supply member 42 and the circulation member 43. When the bubbles are temporarily supplied to the spray nozzle 41, the discharge of the processing liquid from the spray nozzle 41 is disturbed and becomes unstable. However, since the bubbles can be discharged from the supply member 42 and the circulation member 43, the bubbles are less likely to be supplied to the spray nozzle 41, the unstable discharge of the processing liquid caused by the supply of the bubbles to the spray nozzle 41 is restrained, and the stable discharge of the processing liquid from the spray nozzle 41 can be achieved.

The controller 80 executes the process of S4 until the platen 12 reaches the processing liquid discharge region P4 from the setting position P1. Then, the controller 80 executes the process of S6 when the platen 12 reaches the processing liquid discharge region P4. Accordingly, it is possible to shorten the time from when the platen 12 reaches the processing liquid discharge region P4 to when the processing liquid is discharged from the spray nozzle 41 as compared to that when the platen 12 reaches the processing liquid discharge region P4 and then the pump 45 is activated.

In addition, the controller 80 executes the process of S2 and then executes the process of S4. Accordingly, it is possible to restrain unnecessary activation of the pump 45 before the platen 12 starts moving from the setting position P1 to the processing liquid discharge region P4. Therefore, it is possible to reduce the unnecessary activation time of the pump 45 in a period until the discharge of the processing liquid from the spray nozzle 41 is started.

Further, when ending the discharge of the processing liquid from the spray nozzle 41, the controller 80 executes the process of S8 and then executes the process of S9. Accordingly, it is possible to restrain the dripping of the processing liquid from the spray nozzle 41 when the discharge of the processing liquid from the spray nozzle 41 is ended.

Further, the controller 80 executes the process of S8 at a timing at which the platen 12 passes through the processing liquid discharge region P4. Accordingly, it is possible to effectively restrain the dripping of the processing liquid from the spray nozzle 41 when the platen 12 reaches a position where the discharge of the processing liquid is ended, and it is possible to eliminate the unnecessary discharge of the processing liquid from the spray nozzle 41.

The valve 44 in the present embodiment is a three-way valve. Accordingly, the responsiveness of the state switching between the first state and the second state of the valve 44 is improved, and the supply pressure of the processing liquid to the spray nozzle 41 is further stabilized. In a case where flow path switching between the supply member 42 and the circulation member 43 is temporarily performed by using two valves instead of the three-way valve, a deviation is likely to occur at a switching timing between the valves. Further, an increase in the number of components, and an increase in a space for installing the components resulting from the increase in the number of components cause an increase in size and the like. However, since the three-way valve is adopted in the present embodiment, it is possible to achieve space saving and reduction in the number of components.

As a modification, two valves 244 and 245 may be used as the valve 44 of the processing liquid discharge unit 40 instead of the three-way valve. As illustrated in FIG. 8, a processing liquid discharge unit 240 in this modification includes the two valves 244 and 245 instead of the valve 44, and the one end of the circulation member 43 is connected to the supply member 42. The valve 244 is provided in the supply member 42 between the spray nozzle 41 and the pump 45, and the valve 245 is provided at a middle portion of the circulation member 43.

These valves 244 and 245 are selectively set to the first state or the second state under the control of the controller 80. In the first state, the valve 244 is set to the cut-off state where the communication between the pump 45 and the spray nozzle 41 is cut off. In the first state, the valve 245 is set to the communication state where the flow from the supply member 42 to the circulation member 43 is possible. In the second state, the valve 244 is set to the communication state where the pump 45 and the spray nozzle 41 communicate with each other. In the second state, the valve 245 is set to the cut-off state where the flow from the supply member 42 to the circulation member 43 is cut off.

Even in such a modification, the controller 80 controls the states of the two valves 244 and 245 to be the same as those in the embodiment described above, so that when the processing liquid is discharged from the spray nozzle 41, the processing liquid can temporarily flow from the supply member 42 to the circulation member 43 and then be supplied to the spray nozzle 41. That is, the processing liquid is supplied to the spray nozzle 41 in a state where the supply pressure of the processing liquid in the supply member 42 is increased. Therefore, as in the embodiment described above, the processing liquid is easily discharged in the form of mist from the spray nozzle 41 when the supply of the processing liquid to the spray nozzle 41 is started. Also in this modification, the same effect can be obtained in the same configuration as that of the embodiment described above. When the supply pressure of the processing liquid by the pump 45 is high, only the valve 244 may be set to the second state in S6. In addition, it is desirable that operation timings of the valves 244 and 245 in the present modification be the same, or the valve 244 is operated and then the valve 245 is operated.

Although the preferred embodiment of the present disclosure have been described above, the present disclosure is not limited to the embodiment described above, and various modifications can be made within the scope of the claims.

In the embodiment described above and the modifications, the other end of the circulation member 43 is connected to the tank 49, and the other end of the circulation member 43 may be connected to the supply member 42 between the pump 45 and the tank 49. In addition, the filter 46 may be provided in a part of the supply member 42 other than the part between the pump 45 and the tank 49, or may be provided in the circulation member 43. The printing apparatus 1 may be provided with a supply device that supplies the processing liquid to the tank 49.

In addition, the processing liquid discharge unit 40 according to the embodiment described above and the modifications has seven spray nozzles 41, and the processing liquid discharge unit 40 may have one to six, eight or more spray nozzles 41. In this case, the supply member 42, the circulation member 43, the valve 44 (or the valves 244 and 245), and the pump 45 may be provided corresponding to the respective spray nozzles 41 in advance. Further, the supply member 42 connecting the valve 44 (the valve 244) and the spray nozzle 41 may be branched and connected to the plurality of spray nozzles 41. In this way, it possible to reduce the number of the provided valves 44 (the valves 244 and 245) and the number of the provided pumps 45.

Further, the processing liquid discharge unit 40 discharges the processing liquid for forming the lower base layer from the spray nozzle 41, and may discharge a processing liquid for overcoating the image on the printing medium from the spray nozzle 41. In this case, the same process as in S4 may be executed after the printing process in S11, that is, until the platen 12 passes through the printing region P3 and then reaches the processing liquid discharge region P4, and then the same process as in S6 may be executed when the platen 12 reaches the processing liquid discharge region P4. In this way, the image on the printing medium can be overcoated (the upper base layer of the ink can be formed). In addition, the discharge of the processing liquid from the spray nozzle 41 at this time is also the same as in the embodiment described above, the processing liquid is easily discharged in the form of mist from the spray nozzle 41 when the supply of the processing liquid to the spray nozzle 41 is started.

After S1 (YES), the controller 80 may execute S4 before S2 is executed. In addition, the filter 46 may not be provided. The platen moving mechanism 14 may not include the sub scanning motor 26. In this case, the platen 12 may be moved manually. In other words, the conveyance mechanism may have a configuration capable of moving the platen 12 between the setting position P1 and the passing position where the platen 12 passes through the processing liquid discharge region P4.

The heads 30 according to the embodiment described above and the modifications have been described as an example in which the present disclosure is applied to a printing apparatus including a serial head that discharges an ink from a plurality of nozzles while moving along the main scanning direction (the left-right direction) by the moving mechanism 77, but the present disclosure is not limited thereto. For example, the present disclosure can also be applied to a printing apparatus including a line head extending over the entire length of the printing medium (the platen 12) in the main scanning direction and disposed not to be movable in the discharge region B2.

In the controller 80 according to the embodiment described above and the modifications, a microcomputer, an application specific integrated circuit (ASIC), a field programmable gate array (FPGA), or the like may be used as a processor instead of the CPU 81. In this case, a main process may be distributed and executed by a plurality of processors. A non-transitory storage medium such as the ROM 82 and the flash memory 84 may be any storage medium capable of storing information in advance regardless of a period during which the information is stored. The non-transitory storage medium may not include a transitory storage medium (for example, a transmitted signal). For example, the control programs may be downloaded (that is, transmitted as transmission signals) from a server connected to a network (not shown) and stored in the ROM 82 or the flash memory 84. In this case, the control programs may be stored in a non-transitory storage medium such as an HDD provided in the server.

The printing apparatus 1 according to the embodiment described above and the modifications includes the heads 30, the moving mechanism 77, and the like used for forming the image on the printing medium, and may include the processing liquid discharge device including the processing liquid discharge unit 40, the platen 12, the platen moving mechanism 14 and the controller 80. That is, the processing liquid discharge device is not particularly limited to the printing apparatus.

In the embodiment described above and the modifications, the volatile component of the processing liquid includes an organic acid, but the present disclosure is not limited thereto. That is, the volatile component of the processing liquid may include a component other than the organic acid, which reacts with the ink in the nozzles to cause aggregation or discoloration.

The embodiments disclosed here are illustrative in all respects and should be considered not restrictive. The technical features described in each embodiment may be combined with each other, and the scope of the present invention is intended to include all modifications within the scope of the claims and the scope of equivalents to the scope of the claims.

What is claimed is:

1. A processing liquid discharge device comprising:
an accommodation unit configured to accommodate a processing liquid for forming a lower base layer or an upper base layer of an ink discharged onto a printing medium by using an ink jet printer;
a spray nozzle configured to discharge the processing liquid accommodated in the accommodation unit;
a supply flow path for supplying the processing liquid from the accommodation unit to the spray nozzle;
a pump provided in the supply flow path and configured to supply the processing liquid accommodated in the accommodation unit to the spray nozzle;
a valve provided in the supply flow path between the spray nozzle and the pump;
a circulation flow path including one end being connected to the supply flow path between the valve and the pump, or to the valve, and the other end being connected to the supply flow path between the pump and the accommodation unit, or to the accommodation unit; and
a controller configured to control the pump and the valve,
wherein, when causing the processing liquid to be discharged from the spray nozzle, the controller controls the valve to be set in a communication state where the pump and the spray nozzle communicate with each other after activating the pump to cause the processing liquid to flow from the supply flow path to the circulation flow path while controlling the valve to be set in a cut-off state where communication between the pump and the spray nozzle is cut off.

2. The processing liquid discharge device according to claim 1,
wherein the controller controls the valve to be in the communication state after a predetermined time has elapsed since the controller has started to activate the pump.

3. The processing liquid discharge device according to claim 1 further comprising:
a filter that filters an impurity from the processing liquid is provided in the supply flow path.

4. The processing liquid discharge device according to claim 1,
wherein the other end of the circulation flow path is connected to the accommodation unit.

5. The processing liquid discharge device according to claim 1 further comprising:
a platen configured to support the printing medium; and
a platen moving mechanism configured to move the platen between a setting position where the printing medium is set to be supported by the platen and a discharge position where the processing liquid is discharged from the spray nozzle to the printing medium supported by the platen,
wherein the controller activates the pump until the platen reaches the discharge position from the setting position, and controls the valve to be in the communication state when the platen reaches the discharge position.

6. The processing liquid discharge device according to claim 5,
wherein the controller activates the pump after the platen starts moving from the setting position to the discharge position.

7. The processing liquid discharge device according to claim 1,
wherein, when finishing the discharge of the processing liquid from the spray nozzle, the controller stops activating the pump after controlling the valve to be set from the communication state to the cut-off state.

8. The processing liquid discharge device according to claim 7 further comprising:
a platen configured to support the printing medium; and
a platen moving mechanism configured to move the platen between a setting position where the printing medium is set to be supported by the platen and a passing position where the platen passes, through a discharge region in which the processing liquid is discharged from the spray nozzle to the printing medium supported by the platen, from the setting position,
wherein when the platen reaches a discharge end position where the discharge of the processing liquid from the spray nozzle is finished, the discharge end position being provided between the setting position and the passing position, the controller stops activating the pump after controlling the valve to be set from the communication state to the cut-off state.

9. The processing liquid discharge device according to claim 1,
wherein the one end of the circulation flow path is connected to the valve, and
wherein the valve is a three-way valve by which a communication state where the circulation flow path and the supply flow path communicate with each other is set when the cut-off state where the communication between the pump and the spray nozzle is cut off is set, and a cut-off state where the communication between the circulation flow path and the supply flow path is cut off is set when the communication state where the pump and the spray nozzle are communicated with each other is set.
